(19) United States
(12) Patent Application Publication
(10) Pub. No.: US 2023/0119926 A1
(43) Pub. Date: Apr. 20, 2023

(54) SUPPORTING RANDOM ACCESS UPLOADS TO AN OBJECT STORE

(71) Applicant: VMware, Inc., Palo Alto, CA (US)

(72) Inventors: David Mark William Byard, Palo Alto, CA (US); Manu Pratap Singh, Boston, MA (US); Ankit Shah, Boston, MA (US)

(73) Assignee: VMware, Inc., Palo Alto, CA (US)

(21) Appl. No.: 17/502,166

(22) Filed: Oct. 15, 2021

(51) Int. Cl. G06F 3/06

(52) U.S. Cl. CPC G06F 3/064; G06F 3/0644; G06F 3/0608; G06F 3/0664; G06F 3/067

(57) ABSTRACT

An object storage system can receive chunks of an object. Each of the chunks includes data that is a subset of the object. Each subset has an arbitrary amount of data and at least two of the subsets include overlapping data. Each of the chunks is associated with a timestamp. Responsive to a request for the object the object storage system can reconstitute the object by including the subset of data from a most recent of the chunks based on the timestamps and including only nonoverlapping data from subsequent chunks in reverse chronological order based on the timestamps until the object is reconstituted. The object storage system can transmit the reconstituted object.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Some cloud storage systems operate as object storage systems. An object storage system may be stateless and may not provide random access for uploads, resumption of interrupted uploads, or correction of wrong portions of uploads.

### BRIEF DESCRIPTION OF THE DRAWINGS

FIG. 1 illustrates an example of uploading chunks of a file to a network attached storage system according to some previous approaches.

FIG. 2 illustrates an example of uploading chunks of a file to a network attached storage system in a cross domain solution.

FIG. 3 illustrates an example of substitution of an object storage system for a network attached storage system.

FIG. 4 illustrates an example of uploading chunks of a file to an object storage system according to a number of embodiments of the present disclosure.

FIG. 5 illustrates an example of downloading chunks of a file from an object storage system according to a number of embodiments of the present disclosure.

FIG. 6 illustrates an example of downloading overlapping chunks of a file from an object storage system according to a number of embodiments of the present disclosure.

FIG. 7 is a block diagram of a system for uploading chunks to object storage according to a number of embodiments of the present disclosure.

FIG. 8 is a block diagram of an object storage system for uploading chunks to object storage according to a number of embodiments of the present disclosure.

FIG. 9 illustrates an example of uploading chunks to object storage and reconstituting an object according to a number of embodiments of the present disclosure.

FIG. 10 is a flow chart illustrating a method for uploading chunks to object storage according to a number of embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

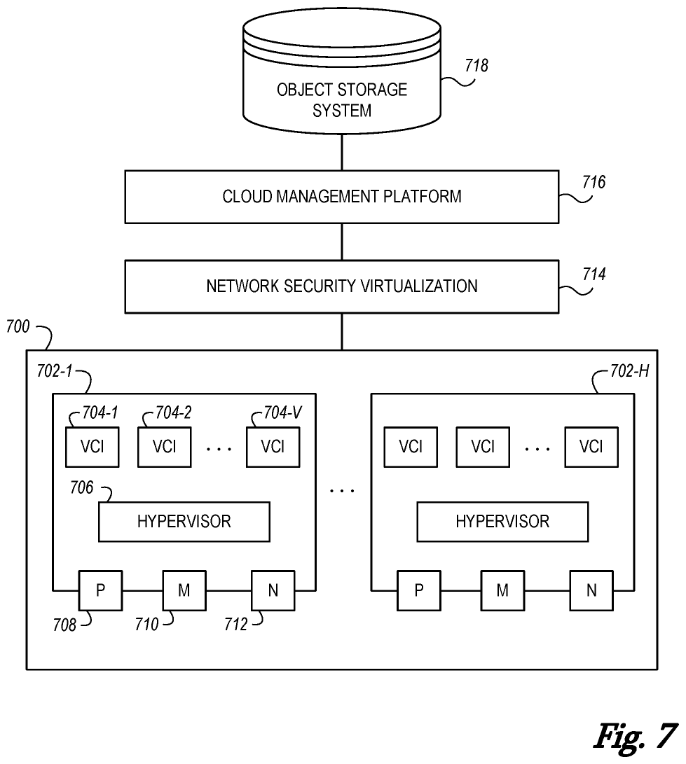

As used herein with respect to VCIs, a “disk” is a representation of memory resources (e.g., memory resources 710 illustrated in FIG. 7) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

Object storage systems typically do not provide random access for uploads. Random access for uploads to storage would allow any number of clients to upload any amount of data at any time for a particular object. Object storage systems typically do not provide for resumption of interrupted uploads or correction of wrong portions of uploads. Although some object storage systems may allow for portions (e.g., chunks) of an object to be uploaded separately, the chunks cannot be overlapping. At least one embodiment of the present disclosure addresses these and other deficiencies of some previous approaches by supporting random access for uploads of chunks of arbitrary amounts and/or overlapping portions of data of an object to an object storage system. Additional benefits include improving the speed of uploads by allowing for a parallelized upload process.

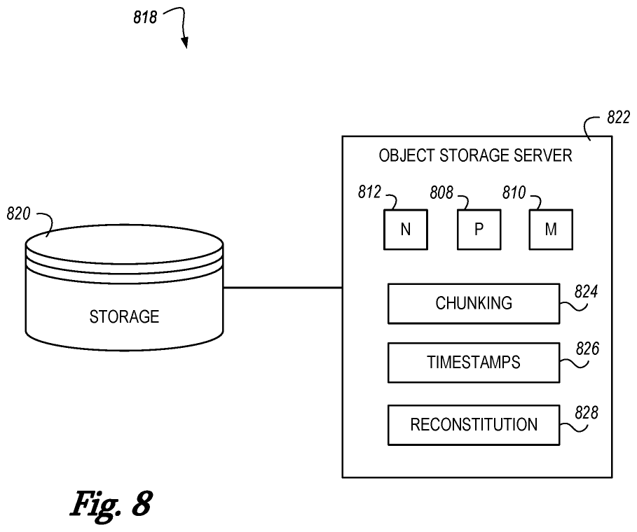

The figures herein follow a numbering convention in which the first digit or digits correspond to the drawing figure number and the remaining digits identify an element or component in the drawing. Similar elements or components between different figures may be identified by the use of similar digits. For example, 718 may reference element “18” in FIG. 7, and a similar element may be referenced as 818 in FIG. 8. Analogous elements within a Figure may be referenced with a hyphen and extra numeral or letter. See, for example, elements 704-1, 704-2, 704-V in FIG. 7. Such analogous elements may be generally referenced without the hyphen and extra numeral or letter. For example, elements 704-1, 704-2, 704-V may be collectively referenced as 704. As used herein, the designators “H” and “V”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

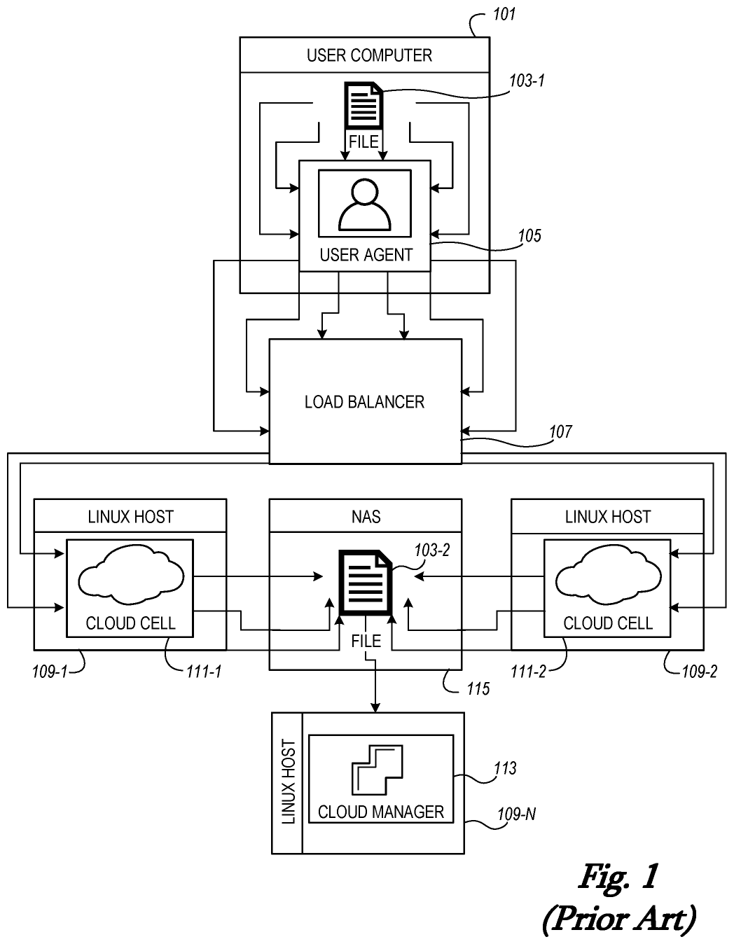

FIG. 1 illustrates an example of uploading chunks of a file 103-1 to a network attached storage (NAS) system 115 according to some previous approaches. In FIG. 1, the NAS system 115 is a network file system (NFS) configured to store data at a file level (e.g., as opposed to a block level). The NAS system 115 can be a network appliance, a server, or other hardware. The NAS system 115 includes memory resources and can include processing resources. A user computer 101 initially stores the file 103-1. The user wishes to upload the file 103-1 to the NAS system 115. A user agent 105 on the user computer 101 can read chunks of the file 103-1 as indicated by the arrows directed from the file 103-1 to the user agent 105 and throughout FIG. 1. The user agent 105 represents the execution of instructions to allow interaction (e.g., uploading the file 103-1) with the rest of the infrastructure illustrated in FIG. 1. Examples of the user agent 105 include a user interface, a web browser extension, etc.

The user computer 101 and thus the user agent 105 are connected to other infrastructure illustrated in FIG. 1 by a load balancer 107. The load balancer 107 can be hardware and/or software configured to distribute network traffic (e.g., signals indicative of the file 103) for multiple hosts 109 and/or user computers 101. As illustrated, the load balancer 107 can distribute a first portion of the chunks of the file 103 to a first host 109-1 (e.g., a Linux host) and a second portion of the chunks of the file 103-1 to a second host 109-2 with the intent that the hosts 109 share the load of uploading the file 103-1 to the NAS system 115. Additional detail regarding hosts is described with respect to FIG. 7. The first host 109-1 can host a first cloud cell 111-1 and the second host 109-2 can host a second cloud cell 111-2. The cloud cells 111 can write their respective chunks of the file 103 to the NAS 115 using random access. The file (e.g., including all of the chunks) is illustrated in the NAS system 115 as file 103-2. The file 103-2 can be uploaded from the NAS system 115 to the cloud manager 113. The cloud manager 113 can be a server configured to manage a software defined data center (e.g., including VCIs, hosts 109, and other components of the infrastructure illustrated in FIG. 1). The approach illustrated in FIG. 1 generally works well for uploading files to an NFS share.

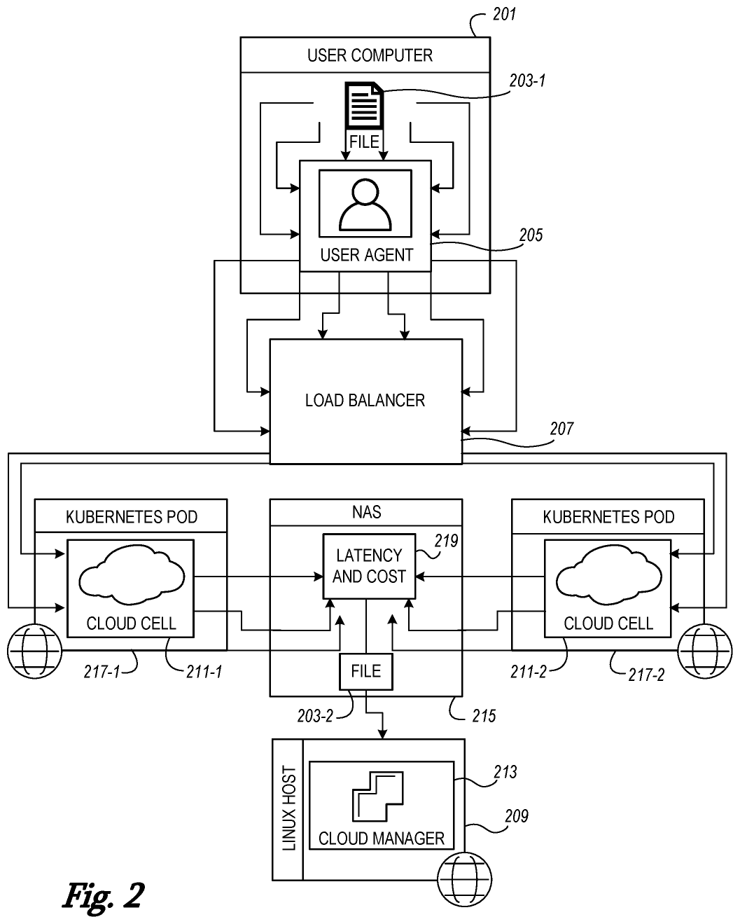

FIG. 2 illustrates an example of uploading chunks of a file 203-1 to a network attached storage system 215 in a cross domain solution. The example environment illustrated in FIG. 2 represents an on-demand cloud computing platform and application program interfaces that is metered on a pay-as-you-go basis. The cloud computing web services of the example environment can provide a variety of basic abstract technical infrastructure and distributed computing building blocks and tools. For example, users can have at their disposal a virtual cluster of computers available through the Internet via server farms.

In contrast to FIG. 1, FIG. 2 illustrates problematic results as “latency and cost” 219 overlaid on the chunks of the uploaded file 203-2 in the NAS system 215. The user computer 201, file 203-1, user agent 205, load balancer 207, host 209, cloud manager 213, and NAS system 215 are analogous to the corresponding elements described above with respect to FIG. 1. However, in the cross domain solution illustrated in FIG. 2, the first cloud cell 211-1 and the second cloud cell 211-2 are provided by containerized applications (e.g., Kubernetes pods) 217-1, 217-2 instead of by non-containerized hosts (e.g., Linux hosts) as illustrated in FIG. 1. Running the NAS 215 in such an environment would cause high latency and costs in comparison to using object storage.

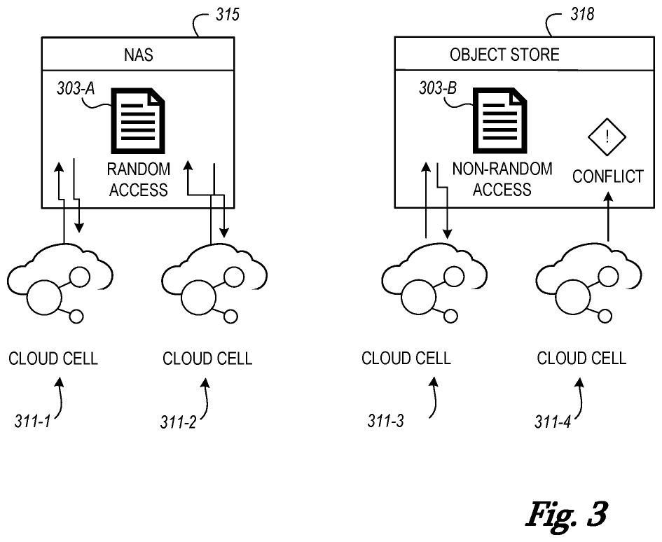

FIG. 3 illustrates an example of substitution of an object storage system 318 for a network attached storage system 315. The NAS system 315 including the file 303-A and the cloud cells 311-1, 311-2 are analogous to those described with respect to FIG. 1. The cloud cells 311-1, 311-2 have random access to the uploaded file 303-A. Any cloud cell 311 can access (e.g., write or read) any subset (e.g., chunk) of the file 303-A.

However, simply substituting an object storage system 318 does not maintain the random access to the uploaded file 303-B. For purposes of discussion with respect to object storage systems, the term “file” may be used interchangeably with the term “object” herein. The object storage system 318 does not provide for random access to the file 303-B. Only entire files 303-B can be accessed at once by a cloud cell 311-3, 311-4. The simple substitution of the object storage system 318 for the NAS system 315 can create conflicts and in many cases will not work as desired.

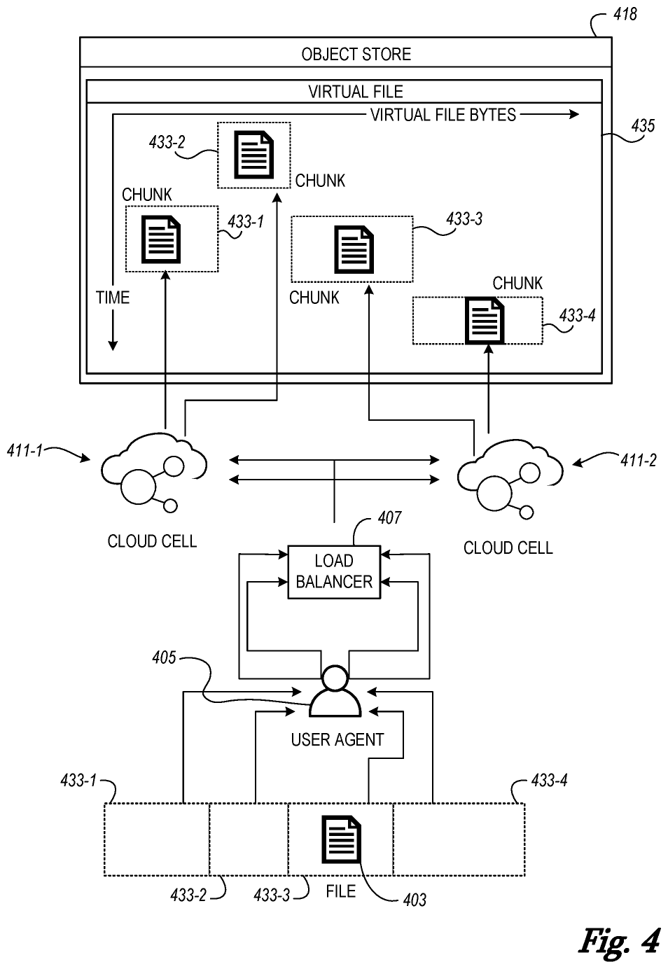

FIG. 4 illustrates an example of uploading chunks 433 of a file 403 to an object storage system 418 according to a number of embodiments of the present disclosure. The file 403, user agent 405, load balancer 407, and cloud cells 411-1, 411-2 are analogous to the corresponding elements described above. In FIG. 4, the file 403 is illustrated as being split into chunks 433-1, 433-2, 433-3, 433-4 of different sizes for upload to the object storage system 418.

According to at least one embodiment of the present disclosure, a virtual file 435 can be created in the object storage system 418. The virtual file 435 can be represented as a folder. The virtual file 435 can be a collection of chunks 433, where each chunk 433-1, 433-2, 433-3, 433-4 is an individual object (e.g., file). Each uploaded chunk 433 of the file 403 can be stored in association with a timestamp (e.g., creation time) and a data range (e.g., a quantity of bytes of the virtual file). By way of example, the timestamp and data range can be stored as part of the filename of each chunk 433 and/or as part of the filename of the virtual file 435. Each cloud cell 411 can therefore upload random chunks 433 of the file 403. Each chunk 433 can be stored without conflict by the object storage system 418.

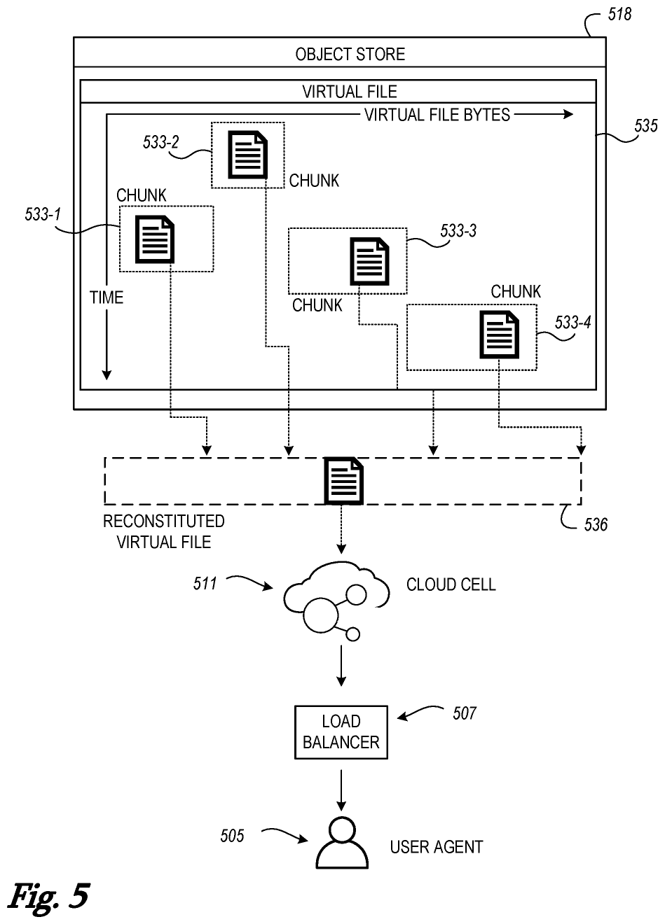

FIG. 5 illustrates an example of downloading chunks 533 of a file from an object storage system 518 according to a number of embodiments of the present disclosure. The user agent 505, load balancer 507, cloud cell 511, object store 518, virtual file 535, and chunks 533 are analogous to the corresponding elements described above. In FIG. 5, although only one cloud cell 511 is illustrated, embodiments are not so limited. Any quantity of cloud cells 511 can participate in downloading the reconstituted file 536. The chunks 533-1, 533-2, 533-3, 533-4 in the virtual file 535 can be collected (e.g., in an ordered sequence) to create the reconstituted file 536, which also may be referred to as a reconstituted virtual file. In some embodiments, the collection of the chunks 533 is performed by the object storage system 518. In some embodiments, the collection of the chunks 533 is performed by the cloud cell 511. In some embodiments, the collection of the chunks 533 is performed by the object storage system 518 and the cloud cell 511.

The reconstituted file 536 is analogous to the file 403 illustrated in FIG. 4, except that it was reconstituted from previously stored chunks 533 for download instead of being divided into chunks and uploaded. The reconstituted file 536 can be downloaded from the file storage system 518 by the cloud cell 511 and to the user agent 505 via the load balancer 507. The downloading process is essentially the reverse of the uploading process described with respect to FIG. 4.

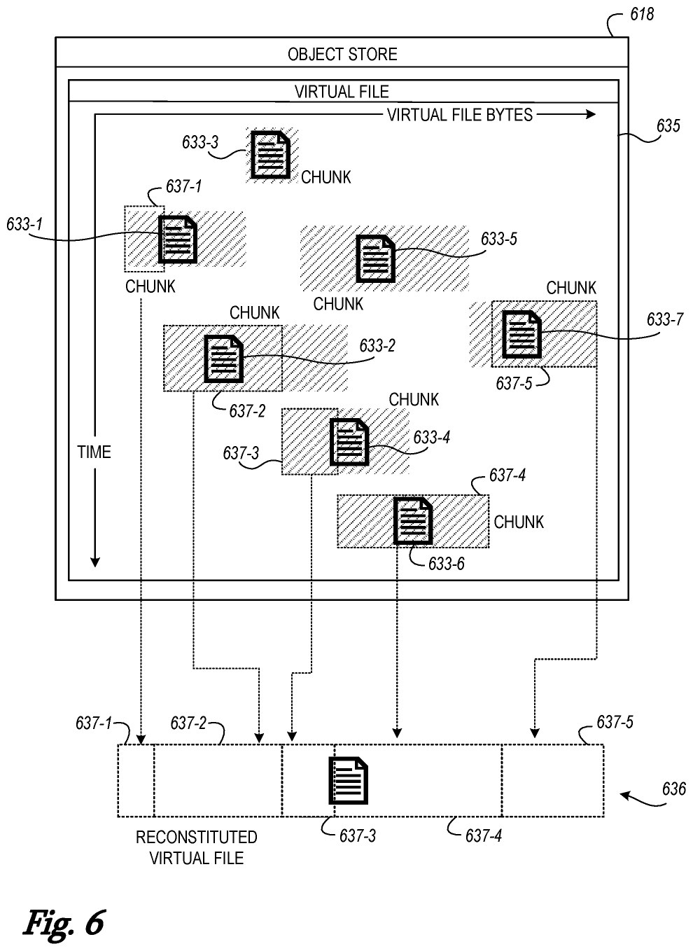

FIG. 6 illustrates an example of downloading overlapping chunks 633 of a file from an object storage system 618 according to a number of embodiments of the present disclosure. The object store 618, virtual file 635, and chunks 633, and reconstituted file 636 are analogous to the corresponding elements described above. In FIG. 6, chunks 633-1, 633-2, 633-3, 633-4, 633-5, 633-7 have been uploaded at various times as indicated by their position with respect to the vertical time axis on the left side of the virtual file 635. As illustrated, the lower the position of a chunk 633 in the virtual file, the more recently it was uploaded to the virtual file 635. Thus, for example, the chunk 633-6 is the most recently uploaded chunk and the chunk 633-3 was the earliest chunk to be uploaded.

The horizontal axis represents an ordering of the bytes of the file (e.g., reconstituted file 636). The order can be from least significant byte on the left to most significant byte on the right. The cross-hatching associated with each chunk 633 illustrates a relative data range of the chunk 633 from left to right.

The arrangement of chunks 633 in the virtual file 635 indicates that some of the data in the chunks 633 overlaps some of the data in other chunks 633. The overlap is indicated by vertically aligning portions of the crosshatch for any two chunks 633. In this context, overlapping data means that the corresponding ordered bytes of data were overwritten by a more recently uploaded chunk 633. For example, the entirety of the chunk 633-3 overlaps a portion of the chunk 633-2. The chunk 633-3 was written earlier in time than the chunk 633-2, indicating that the data associated with the chunk 633-3 is stale and should not be included in the reconstituted file 636. Stale data may be data that was later overwritten because it was changed (e.g., another chunk 633 including updated data for a particular range was later written to the object storage system 618). Stale data may be data that was part of a chunk 633 that was partially uploaded due to an upload failure and then later uploaded again as a new or different chunk 633.

The chunks 633 are saved in the virtual file 635 in the object storage system 618 without regard to the overlapping data. For example, the object storage system 618 does not preemptively determine whether data ranges of various chunks overlap (e.g., in order to reduce unnecessary writes or to preemptively promote a garbage collection process). Rather, the object storage system 618 stores any chunk 633 that is uploaded thereto. A later-in-time upload of a chunk 633 including an overlapping data range with a previously uploaded chunk 633 may be intended to correct a previous upload that partially failed, to provide updated data for at least a portion of the range of the previous chunk, etc. Such embodiments can help provide random read and write access to the file in the object storage system 618. Any portion of the file, such as a chunk 633 or portion of a chunk, can be uploaded or downloaded at any time.

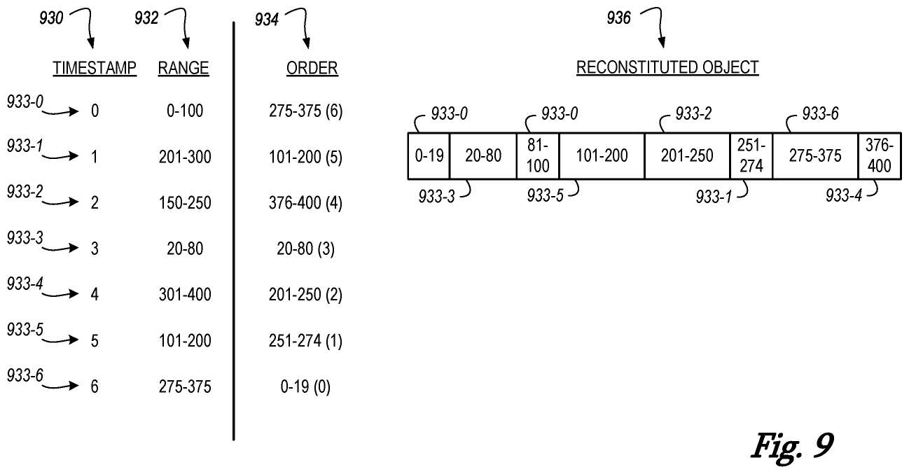

The file can be downloaded from the object storage system 618 as a reconstituted file 636. The chunks 633 can be sorted in reverse chronological order based on timestamps associated with respective uploads of each chunk 633. The file can be reconstituted starting with a most recently uploaded chunk (e.g., chunk 633-6) and then filling in the gaps in the data range of the file. For example, as illustrated in FIG. 6, the reconstituted file 636 can include the data range 637-4 of the chunk 633-6, the data range 637-3 of the chunk 633-4, the data range 637-2 of the chunk 633-2, the data range 637-5 of the chunk 633-7, and the data range 637-1 of the chunk 633-1. The data range 637-4 of the chunk 633-6 includes all of the data of the chunk 633-6. The data range 637-3 of the chunk 633-4 includes only that portion of the data of chunk 633-4 that does not overlap with the chunk 633-6. The data range 637-2 of the chunk 633-2 includes only that portion of the data of the chunk 633-2 that does not overlap with the chunks 633-4, 633-6. The data range 637-5 of the chunk 633-7 includes only that portion of the data of the chunk 633-7 that does not overlap with the chunks 633-4, 633-6, 633-2. The data range 637-1 of the chunk 633-1 includes only that data of the chunk 633-1 that does not overlap with the chunks 633-4, 633-6, 633-2, 633-7. Another example of overlapping data ranges is described with respect to FIG. 9.

FIG. 7 is a block diagram of a system for distributed random access upload of chunks to object storage according to a number of embodiments of the present disclosure. The system can include a cluster 700 in communication with a cloud management platform 716 via a network security virtualization layer 714. The cluster 700 can include a number of hosts 702-1, . . . , 702-H with processing resources 708 (e.g., a number of processors), memory resources 710 (e.g., primary memory such as dynamic random access memory (DRAM)), and/or a network interface 712. Though two hosts 702 are shown in FIG. 7 for purposes of illustration, embodiments of the present disclosure are not limited to a particular number of hosts.

The cluster 700 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

Each host 702 can incorporate a hypervisor 706 that can execute a respective number of VCIs 704-1, 704-2, . . . , 704-V. The VCIs 704 can be provisioned with processing resources 708 and/or memory resources 710 and can communicate via the network interface 712. The processing resources 708 and the memory resources 710 provisioned to the VCIs 704 can be local and/or remote to the host 702. For example, in a software defined data center, the VCIs 704 can be provisioned with resources that are generally available to the software defined data center and not tied to any particular hardware device. By way of example, the memory resources 710 can include volatile and/or non-volatile memory available to the VCIs 704. The VCIs 704 can be moved to different hosts (not specifically illustrated), such that a different hypervisor manages (e.g., executes) the VCIs 704.

The cluster 700 and the hosts 702 can be in communication with the cloud management platform 716 via the network security virtualization layer 714. Although not specifically illustrated, the network virtualization layer 714 can include various functionality such as a logical firewall, logical load balancing, logical virtual private network, logical switching, and logical routing. In some embodiments, the cloud management platform 716 can be a server, such as a web server.

The cloud management platform 716 can be in communication with an object storage system 718 to provide storage for the cluster 700. In some embodiments, the object storage system 718 is maintained by a third party while the cloud management platform 716 is maintained by a first party. The object storage system 718 can include physical resources such as processing and memory resources. The object storage system 718 can be configured to provide a data storage structure that manages data as objects as opposed to files or blocks. Each object can include the data itself, metadata, and a unique identifier. The object storage system 718 can store unstructured data. The object storage system 718 can be a cloud storage system, which can provide scalability, high availability, and low latency versus some other storage systems. In contrast to some previous approaches, the cloud storage system 718 according to at least one embodiment of the present disclosure is configured to provide for random access uploads of object chunks as described in more detail herein. An example of the object storage system 718 is illustrated and described in more detail with respect to FIG. 8.

FIG. 8 is a block diagram of an object storage system 818 for uploading chunks to object storage 820 according to a number of embodiments of the present disclosure. The object storage 820 can be in communication with an object storage server 822 via a communication link. The object storage 820 represents persistent storage and can include volatile and/or non-volatile memory. Volatile memory can include memory that depends upon power to store information, such as various types of DRAM among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The object storage server 822 can include processing resources 808, memory resources 810, and a network interface 812. The object storage server 822 can be configured to perform a number of functions described herein. For example, the object storage server 822 can utilize software, hardware, firmware, and/or logic to perform a number of functions. The memory resources 810 (e.g., machine-readable medium) can store program instructions (e.g., software, firmware, etc.), which can be executed by the processing resources 808 to perform the functions described herein.

The memory resources 810 can be internal and/or external to the object storage server 822 (e.g., the object storage server 822 can include internal memory resources and have access to external memory resources). In some embodiments, the object storage server 822 can be a VCI. The program instructions (e.g., machine-readable instructions) can include instructions stored on the machine-readable medium to implement a particular function (e.g., an action such as reconstituting an object from multiple received chunks, as described herein). The set of machine-readable instructions can be executable by one or more of the processing resources 808. The memory resources 810 can be coupled to the object storage server 822 in a wired and/or wireless manner. For example, the memory resources 810 can be an internal memory, a portable memory, a portable disk, and/or a memory associated with another resource, e.g., enabling machine-readable instructions to be transferred and/or executed across a network such as the Internet. The memory resources 810 can be non-transitory and can include volatile and/or non-volatile memory.

The processing resources 808 can be coupled to the memory resources 810 via a communication path. The communication path can be local or remote to the object storage server 822. Examples of a local communication path include an electronic bus internal to a machine, where the memory resources 810 are in communication with the processing resources 808 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path can be such that the memory resources 810 are remote from the processing resources 808, such as in a network connection between the memory resources 810 and the processing resources 808. That is, the communication path can be a network connection. Examples of such a network connection can include a local area network (LAN), wide area network (WAN), SAN, and the Internet, among others.

As shown in FIG. 8, the instructions and/or data associated with the object storage server can be segmented into a number of modules 824, 826, 828. Examples are not limited to the specific modules 824, 826, 828 illustrated in FIG. 8. The chunking module 824 can include instructions to receive chunks of an object. The chunks can be sent from any number of clients and received via the network interface 812. Each chunk is a subset of the object including an arbitrary amount of data (e.g., the amount of data in each chunk is not predefined, constant, or necessarily equal to the amount of data in any other chunk). Different chunks can include overlapping data of the object. The chunking module 824 can store the received chunks without regard to the overlapping data. The chunks can be stored in the object storage 820. Additional detail regarding chunks is provided with respect to FIG. 9.

The timestamps module 826 can include instructions to associate timestamps with each received chunk. The timestamps can be stored in the object storage 820 (e.g., in association with the corresponding chunk or separate therefrom). The respective timestamp for each chunk can indicate a time at which the chunk was received or a time at which the upload of the chunk commenced. This information can be useful for reconstituting the object from the chunks.

The reconstitution module 828 can include instructions to reconstitute the object from the received chunks (e.g., in response to a request for the object). The object can be reconstituted by including a subset of the data of the object from a most recently received chunk (based on the timestamps) and including only nonoverlapping data of the object from subsequent chunks in reverse chronological order in which they were received until all of the data of the object has been included in the reconstituted object. The process for reconstituting the object is described in more detail with respect to FIG. 9. The object storage server 822 can cause the reconstituted chunk to be transmitted (e.g., via the network interface 812) from the object storage system 818.

FIG. 9 illustrates an example of uploading chunks 933 to object storage and reconstituting an object according to a number of embodiments of the present disclosure. In this example, the object is 400 megabytes (400,000,000 bytes) and seven chunks 933-0, 933-1, 933-2, 933-3, 933-4, 933-5, 933-6 are uploaded. The size of the object and quantity of chunks are presented in a concise fashion for ease of illustration and explanation. In operation, objects can be any size (e.g., significantly smaller or larger than 400 megabytes) and can be uploaded as any quantity of chunks. Each chunk 933 is associated with a timestamp 930, which are illustrated simply as 0-6 to indicate the order in which the chunks 933 were uploaded. In operation, the timestamp 930 can be an actual time or a count or some other value indicative of the order in which the chunks 933 were uploaded.

Each chunk 933 includes a range 932 of data, which, for ease of illustration, is presented as the numbered order of megabytes of each chunk 933, however embodiments are not limited to the use of megabytes as a designator for sizes. Other designators for sizes can be used, such as bits, bytes, gigabytes, etc. For example, chunk 933-0 includes megabytes numbered 0-100 d chunk 933-1 includes megabytes numbered 201-300 of the object, which includes a total quantity of 400 megabytes. However, in some embodiments, the range can be represented with offsets from a beginning and end of the object rather than numbered megabytes. For example, the chunk 933-1, which includes numbered megabytes 201-300 can be represented by the offset-defined range (201, 100), where 201 represents a start offset from numbered megabyte 0 (the beginning of the object) and 100 represents an end offset from numbered megabyte 400 (the end of the object).

As can be seen in FIG. 9, some of the chunks 933 include overlapping data. For example, chunk 933-1 includes numbered megabytes 201-300 and chunk 933-2 includes numbered megabytes 150-250, such that numbered megabytes 201-250 are included in both chunks 933-1, 933-2. However, according to the present disclosure, the entirety of each chunk 933 is saved in the object storage system without regard to overlapping data. The storage overhead associated with storing such overlapping data is offset by the relative increase in speed for not slowing down or stopping uploads that include overlapping data or performing data deduplication in conjunction with uploads and/or writes to the object storage system. Thus, the object storage system allows random access for uploads of data (chunks 933) constituting an object. In some embodiments, the object storage system can store the chunks in a redundant array of independent disks (RAID) array. The chunks 933 can come from a single source (e.g., client) or multiple sources (e.g., clients). More than one chunk 933 can be received in parallel (e.g., at the same time or overlapping times). The amount of data and which portions of the object that are included in each chunk 933 is arbitrary. The chunks 933 do not have to be predefined before an upload begins. The object storage system does not specify constraints for object size (e.g., a constraint such as each chunk must be 50 megabytes). One or more clients can start, stop, and/or resume uploading any of the data constituting the object at any time. For example, a client can stop uploading data constituting the object due to a network connection problem or an interruption caused by load balancing (e.g., a client could be uploading numbered megabytes starting with 0 and continue through numbered megabyte 100 before the upload interruption, thus having uploaded the chunk 933-0).

In at least one embodiment, the chunks 933 are sorted in reverse chronological order 934 based on the timestamps 930. The object can be reconstituted from the chunks 933 (e.g., in response to a request for the object). The object can be reconstituted starting with a most recently received chunk 933-6 based on the timestamps 930 (e.g., timestamp 6 in this example). All of the data of the most recently received chunk 933-6 can be included in the reconstituted object 936. In this example, that means that numbered megabytes 275-375 from chunk 933-6 are included in the reconstituted object 936. Non-overlapping data from subsequent chunks 933 in reverse chronological order 934 based on the timestamps 930 is included in the reconstituted object until all of the data of the object has been included. With respect to reconstitution of the object, non-overlapping data means data that has not previously been included in the reconstituted object based on the order 934 in which data is gathered from the chunks 933. Filling the reconstituted object 936 with the most recently received data, even though overlapping data is stored persistently, prevents stale data from being included in the reconstituted object 936. For example, a client may upload a first chunk at a first time and subsequently upload a second chunk at a second time, later than the first time, that includes corrected data for the first chunk.

In the example illustrated in FIG. 9, data from the chunk 933-5 (numbered megabytes 101-200) is included in the reconstituted object 936 because none of the numbered megabytes 101-200 were included with chunk 933-6. Data from the chunk 933-4 is included in the reconstituted object 936, but only numbered megabytes 376-400 (out of 301-400) because numbered megabytes 301-375 were included from the chunk 933-6. Data from the chunk 933-3 is included in the reconstituted object 936. All numbered megabytes 20-80 of the chunk 933-3 are included because none of them were included with chunks 933-6, 933-5, or 933-4. Data from chunk 933-2 is included in the reconstituted object 936, but only numbered megabytes 201-250 (out of 150-250) because numbered megabytes 150-200 were included from the chunk 933-5. Data from the chunk 933-1 is included in the reconstituted object 936, but only numbered megabytes 251-274 (out of 201-300) because numbered megabytes 201-250 were previously included from chunk 933-2 and numbered megabytes 275-300 were included from chunk 933-6. Data from the chunk 933-0 is included in the reconstituted object 936, but only numbered megabytes 0-19 and 81-100 (out of 0-100) because numbered megabytes 20-80 were included from chunk 933-3.

As a result, the reconstituted object 936 includes numbered megabytes 0-19 from the chunk 933-0, numbered megabytes 20-80 from the chunk 933-3, numbered megabytes 81-100 from the chunk 933-0, numbered megabytes 101-200 from the chunk 933-5, numbered megabytes 201-250 from the chunk 933-2, numbered megabytes 251-274 from the chunk 933-1, numbered megabytes 275-375 from the chunk 933-6, and numbered megabytes 376-400 from the chunk 933-4.

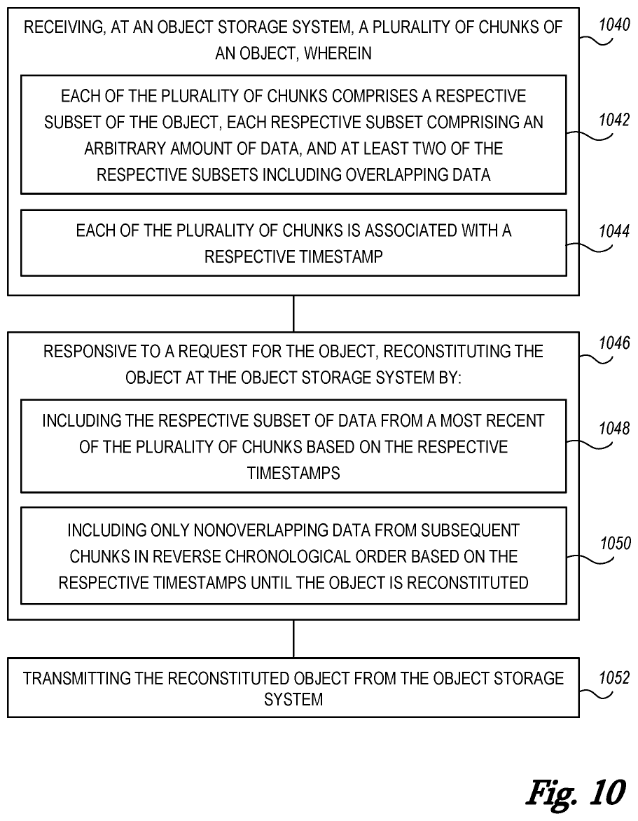

FIG. 10 is a flow chart illustrating a method for uploading chunks to object storage according to a number of embodiments of the present disclosure. At 1040, the method can include receiving, at an object storage system, chunks of an object. As indicated at 1042, each chunk is a respective subset of the object having an arbitrary amount of data. Each chunk is associated with a respective data range. In some embodiments, the data range is represented by a start offset and an end offset with respect to the object, as described herein. At least two of the subsets (chunks) include overlapping data. Each chunk can be saved in persistent storage without regard to the overlapping data. As indicated at 1044, each chunk is associated with a respective timestamp. The timestamp can be assigned by the object storage system when the upload of a chunk begins or when the upload of the chunk completes. In at least one embodiment, the chunks can be stored in reverse chronological order based on the respective timestamps.

At 1046, the method can include reconstituting the object at the object storage system in response to a request for the object. If there is no request for the object, then the chunks can be stored in the object storage system without data deduplication. As indicated at 1048, reconstituting the object can include including the respective subset of data from a most recent of the chunks based on the respective timestamps. As indicated at 1050, reconstituting the object can include including only nonoverlapping data from subsequent chunks in reverse chronological order based on the respective timestamps until the object is reconstituted. The method can include determining whether to include any of the data from the subsequent chunks based on the respective data range in order to include only nonoverlapping data from subsequent chunks in the reconstituted object.

At 1052, the method can include transmitting the reconstituted object from the object storage system. In at least one embodiment, such transmission can begin while the object is being reconstituted as a virtual stream (e.g., when data from one or more chunks has been included in the reconstituted object). Although not specifically illustrated, in response to a request for a portion of the object having a particular data range, the method can include reconstituting the portion of the object and transmitting the reconstituted portion of the object. The portion of the object can be reconstituted analogously to the reconstitution of the entire object. For example, only data that overlaps the particular range from a most recent of the plurality of chunks based on the respective timestamps and the respective data ranges can be included in the reconstituted portion of the object. Only data that overlaps the particular data range, but does not overlap previously included data, from subsequent chunks in reverse chronological order can be included in the reconstituted portion of the object based on the respective timestamps and the respective data ranges until the portion of the object is reconstituted. Accordingly, some embodiments of the present disclosure can provide random access downloads of objects and/or portions of objects from an object storage system.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, at an object storage system, a plurality of chunks of an object, wherein:
each of the plurality of chunks comprises a respective subset of the object, each respective subset comprising an arbitrary amount of data, and at least two of the respective subsets including overlapping data; and
each of the plurality of chunks is associated with a respective timestamp; and
responsive to a request for the object, reconstituting the object at the object storage system by:
including the respective subset of data from a most recent of the plurality of chunks based on the respective timestamps; and
including only nonoverlapping data from subsequent chunks in reverse chronological order based on the respective timestamps until the object is reconstituted; and
transmitting the reconstituted object from the object storage system.

2. The method of claim 1, further comprising saving the plurality of chunks in persistent storage without regard to the overlapping data.

3. The method of claim 2, wherein each of the plurality of chunks is associated with a respective data range comprising a start offset and an end offset with respect to the object; and
wherein the method further comprises sorting the plurality of chunks in reverse chronological order based on the respective timestamps.

4. The method of claim 3, wherein including only nonoverlapping data from subsequent chunks further comprises determining whether to include any of the data from the subsequent chunks based on the respective data range.

5. The method of claim 3, further comprising, responsive to a request for a portion of the object having a particular data range, reconstituting the portion of the object; and
transmitting the reconstituted portion of the object.

6. The method of claim 5, wherein reconstituting the portion of the object comprises:
including only data that overlaps the particular data range from a most recent of the plurality of chunks based on the respective timestamps and the respective data ranges; and
including only data that overlaps the particular data range, but does not overlap previously included data, from subsequent chunks in reverse chronological order based on the respective timestamps and the respective data ranges until the portion of the object is reconstituted.

7. The method of claim 1, wherein receiving the plurality of chunks comprises receiving different chunks from different sources.

8. A non-transitory machine-readable medium having instructions stored thereon which, when executed by a processor, cause the processor to:
receive, at an object storage system, a plurality of chunks of an object, wherein:
each of the plurality of chunks comprises a respective subset of the object, each respective subset comprising an arbitrary amount of data, and at least two of the respective subsets including overlapping data; and
each of the plurality of chunks is associated with a respective timestamp; and
responsive to a request for the object, reconstitute the object at the object storage system by:
including the respective subset of data from a most recent of the plurality of chunks based on the respective timestamps; and
including only nonoverlapping data from subsequent chunks in reverse chronological order based on the respective timestamps until the object is reconstituted; and
transmit the reconstituted object from the object storage system.

9. The medium of claim 8, further comprising instructions to save the plurality of chunks in persistent storage without regard to the overlapping data.

10. The medium of claim 9, wherein each of the plurality of chunks is associated with a respective data range comprising a start offset and an end offset with respect to the object; and
further comprising instructions to sort the plurality of chunks in reverse chronological order based on the respective timestamps.

11. The medium of claim 10, wherein the instructions to include only nonoverlapping data from subsequent chunks further comprise instructions to determine whether to include any of the data from the subsequent chunks based on the respective data range.

12. The medium of claim 10, further comprising instructions to:
reconstitute the portion of the object responsive to a request for a portion of the object having a particular data range; and
transmit the reconstituted portion of the object.

13. The medium of claim 12, wherein the instructions to reconstitute the portion of the object comprise instructions to:
include only data that overlaps the particular data range from a most recent of the plurality of chunks based on the respective timestamps and the respective data ranges; and
include only data that overlaps the particular data range, but does not overlap previously included data, from subsequent chunks in reverse chronological order based on the respective timestamps and the respective data ranges until the portion of the object is reconstituted.

14. The medium of claim 8, wherein the instructions to receive the plurality of chunks comprise instructions to receive different chunks from different sources.

15. An object storage system, comprising processing and memory resources configured to:
receive a plurality of chunks of an object, wherein:
each of the plurality of chunks comprises a respective subset of the object, each respective subset comprising an arbitrary amount of data, and at least two of the respective subsets including overlapping data; and
each of the plurality of chunks is associated with a respective timestamp; and
responsive to a request for the object, reconstitute the object by:
including the respective subset of data from a most recent of the plurality of chunks based on the respective timestamps; and
including only nonoverlapping data from subsequent chunks in reverse chronological order based on the respective timestamps until the object is reconstituted; and
transmit the reconstituted object.

16. The system of claim 15, further configured to save the plurality of chunks in persistent storage without regard to the overlapping data.

17. The system of claim 16, wherein each of the plurality of chunks is associated with a respective data range comprising a start offset and an end offset with respect to the object; and
wherein the system is further configured to sort the plurality of chunks in reverse chronological order based on the respective timestamps.

18. The system of claim 17, further configured to determine whether to include any of the data from the subsequent chunks based on the respective data range.

19. The system of claim 17, further configured to:
reconstitute the portion of the object responsive to a request for a portion of the object having a particular data range; and
transmit the reconstituted portion of the object.

20. The system of claim 19, wherein the system is configured to reconstitute the portion of the object by:
including only data that overlaps the particular data range from a most recent of the plurality of chunks based on the respective timestamps and the respective data ranges; and
including only data that overlaps the particular data range, but does not overlap previously included data, from subsequent chunks in reverse chronological order based on the respective timestamps and the respective data ranges until the portion of the object is reconstituted.
